(19) United States
(12) Patent Application Publication
(10) Pub. No.: US 2019/0018188 A1
(43) Pub. Date: Jan. 17, 2019

(54) OPTICAL FILTER AND OPTICAL DEVICE USING THE SAME

(71) Applicant: Samsung Electronics Co., Ltd., Suwon-si, Gyeonggi-do (KR)

(72) Inventors: Kyeong Seok LEE, Seoul (KR); Gyu Weon HWANG, Seoul (KR); In Ho KIM, Seoul (KR); Won Mok KIM, Seoul (KR); Wook Seong LEE, Seoul (KR); Doo Seok JEONG, Seoul (KR)

(73) Assignee: Samsung Electronics Co., Ltd., Suwon-si, Gyeonggi-do (KR)

(21) Appl. No.: 16/070,319

(22) PCT Filed: Jul. 31, 2017
(86) PCT No.: PCT/KR2017/008257

§ 371 Date: Jul. 16, 2018

(30) Foreign Application Priority Data
Aug. 30, 2016 (KR) 10-2016-0110789

(51) Int. Cl. G02B 6/12; G02B 6/124; G01J 1/04

(52) U.S. Cl. CPC G02B 6/12007; G02B 6/124; G01J 1/0488; G01J 1/44; G02B 2006/12138; G02B 2006/12107; G02B 2006/12109

(57) ABSTRACT

Provided is an optical filter including a cladding layer, a plurality of metal patterns configured to form a periodic lattice structure on the cladding layer; and an optical waveguide layer on the plurality of metal patterns. Light travels from the optical waveguide layer to the cladding layer. Provided is an optical device using the optical filter.

### TECHNICAL FIELD

The present invention relates to an optical filter, and more particularly to an optical filter and an optical device having an optical waveguide layer formed on a plurality of metal patterns.

### BACKGROUND ART

An optical filter is a configuration necessary for filtering light having various wavelengths into an arbitrary wavelength band. As an optical filter that transmits only light of a specific wavelength band or transmits different wavelength bands is integrated in an array form, it is used to configure a micro-spectrometer. As a band-pass filter, a Fabry-Perot filter using a light interference effect of a dielectric resonator placed between two reflective films is typical. In addition, a transmission filter using an extraordinary optical transmission (EOT) phenomenon occurring in a nano-hole array structure periodically arranged on a metal thin film structure is used.

The Fabry-Perot filter using the optical interference effect has an advantage in that the control of the transmission central wavelength and the transmission band width is relatively easy, but has a disadvantage in that the formation of the multiple transmission band limits the free spectral range and the incidence angle dependency is high. Unlike the Fabry-Perot filter, the metal nano-hole array structure has an advantage that the central transmission wavelength varies only by controlling the horizontal lattice structure but has a disadvantage in that it has wide bandwidth and various transmission modes are generated due to the coupling between the surface plasmon waves and the lattice mode so that the out-of-band rejection characteristic is poor.

A linear variable filter (LVF) is known as an optical filter array for constituting a spectrometer. The LVF is an optical filter having a Fabry-Perot resonator structure, and has a structure in which the thickness of a dielectric resonance layer varies linearly in the length direction. In the LVF, a lower mirror layer and an upper mirror layer are disposed with a dielectric resonance layer interposed therebetween.

Such an LVF has a limitation in process reproducibility due to the linear structure whose thickness varies in the length direction. In addition, since the resolution of the conventional LVF spectrometer is determined by the height-to-length ratio of the LVF, it has been difficult to downsize the spectrometer. Particularly, due to the linear structure, the process compatibility with the two-dimensional imaging sensor technology is insufficient, so that it is disadvantageous in terms of productivity.

Since the transmission spectrum for each LVF location is made up of successive spectral overlaps and the integration between the LVF and the optical detector is not monolithic, there is a distance between the filter and the array of optical detectors and there is a drawback that the filter performance is deteriorated due to the stray light effect according thereto.

The transmission band filter array for a spectrometer may be manufactured by configuring the lattice period of the metal nano-hole array to be continuously variable. In this case, it is advantageous that the manufacturing process is simplified because only the horizontal structure is controlled. However, presence of the multi-mode may cause distortion in the signal processing process when the spectrometer operates.

In addition, since the half-width is large and the dependence of an incident angle is high, there are many limitations in meeting various demands for optical filters.

### DISCLOSURE OF THE INVENTION

### Technical Problem

The present invention is to provide a band-pass filter with a half-width and an optical filter with excellent out-of-band rejection characteristics.

The present invention also provides an optical filter with a simple manufacturing process and an excellent reliability.

### Technical Solution

Embodiments of the present invention provide an optical filter including: a cladding layer; a plurality of metal patterns configured to form a periodic lattice structure on the cladding layer; and an optical waveguide layer on the plurality of metal patterns, wherein light travels from the optical waveguide layer to the cladding layer.

In an embodiment, the plurality of metal patterns may be patterned to form a two-dimensional slit mesh structure.

In an embodiment, a ratio of a slit width to a period of the plurality of metal patterns may be 1/30 to 1/3.

Embodiments of the present invention provide an optical filter includes: a substrate; a cladding layer on the substrate; a plurality of metal patterns periodically patterned on the cladding layer; and a first optical waveguide layer on the plurality of metal patterns, wherein light travels from the substrate to the first optical waveguide layer.

Embodiments of the present invention provide an optical device includes: the flat plate optical filter; and an optical detector corresponding to the optical filter. The optical device is one of a non-dispersion infrared sensor, a spectrometer, a CMOS image sensor, or a hyper-spectral image sensor.

### Advantageous Effects

According to the invention as described above, it is possible to provide an optical filter having a small half-width and excellent out-of-band rejection characteristics, while easily controlling the center wavelength of a transmission band only by the horizontal structure control.

Further, the process of providing a waveguide layer on the upper portion may be effective for realizing a comparatively simple process, the separation from the optical detector may be minimized, the possibility of optical waveguide structure loss occurring in the metal lattice pattern etching process is minimized, and it is possible to monitor and optimize the thickness in real time during the process and also adds a protective layer function to a metal lattice. Therefore, there is an advantageous effect in the integration process.

### BRIEF DESCRIPTION OF THE DRAWINGS

FIG. 1 is a view showing a section of an optical filter according to an embodiment of the present invention.

FIG. 2 is a perspective view of an optical filter.

FIG. 3 is a view showing examples of a planar structure of metal patterns.

FIG. 4 is a cross-sectional view of an optical filter according to another embodiment of the present invention.

FIG. 5 is a cross-sectional view of an optical filter according to another embodiment of the present invention.

FIGS. 6 to 15 are cross-sectional views of an optical filter according to other embodiments of the present invention.

### MODE FOR CARRYING OUT THE INVENTION

Hereinafter, embodiments of the present invention are described in more detail with reference to the accompanying drawings. However, the following illustrative embodiment of the present invention may be modified into various other forms, and the scope of the present invention is not limited to the embodiments described below. Embodiments of present inventions are provided to more fully describe the present invention to those of ordinary skill in the art.

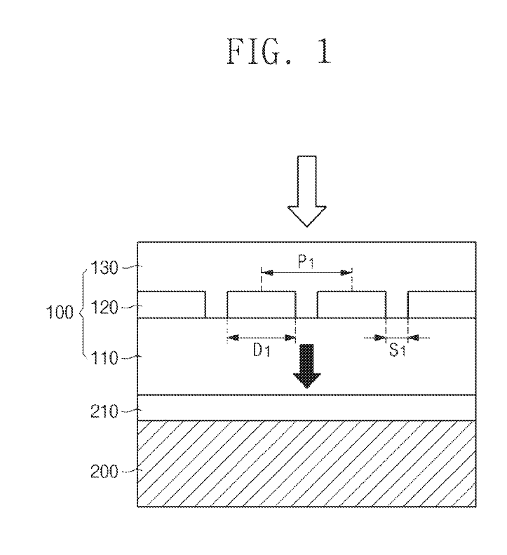

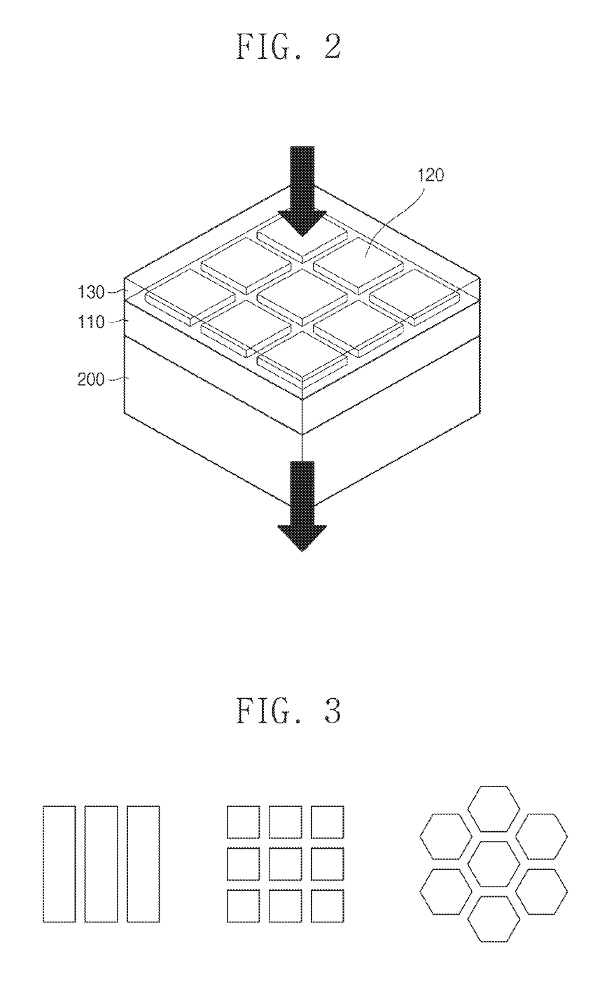

FIG. 1 is a view showing a section of an optical filter according to an embodiment of the present invention. FIG. 2 is a perspective view of an optical filter. FIG. 3 is a view showing examples of a planar structure of a metal pattern.

An optical filter 100 includes a cladding layer 110 and a plurality of metal patterns 120 patterned to have a periodic lattice structure and an optical waveguide layer 130 formed on the plurality of metal patterns 120. One of the characteristic features of the present invention is that the optical waveguide layer 130 is formed on the plurality of metal patterns 120.

At this time, if the lattice period of the metal pattern is configured to be smaller than the central wavelength to be filtered by the optical filter, it operates as a zero-order diffraction grating. By forming neighboring metal patterns and a very narrow mesh-shaped slit structure, the out-of-band rejection effect is excellent, and the transmission central wavelength is dominantly dependent on the lattice period. According to this structure, when a light having a plurality of wavelengths enters through the optical waveguide layer 130 and meets a diffraction grating composed of the plurality of metal patterns 120, the resonance wavelength light of the zero-order characteristic is transmitted through the slit, and on the other hand, a light of ±1 order diffracted in the form of an evanescent field is coupled with the waveguide mode of the backward waveguide. The light coupled in the waveguide mode undergoes a process of meeting the metal pattern lattice structure again and being converted into a propagation mode for penetrating a slit, so that the light of a certain resonance wavelength is filtered out with high transmittance.

The spectrum of the transmission band is greatly influenced by the optical structural factors such as the slit width, refractive index and thickness of the optical waveguide layer in addition to the lattice period. The refractive index of the optical waveguide layer should be higher than the refractive index of the cladding layer and the thickness thereof may within a range of λ₀/4n_{wg}<t_{wg}<λ₀/n_{wg} so as to satisfy the single waveguide mode condition. Here, λ₀ means the transmission central wavelength. If the thickness of the optical waveguide layer is too small, the waveguide mode may not be formed and when out of the range, multi-wave mode occurs, so that the half-width of the transmission band is increased and the multi-transmission band is formed. Therefore, the out-of-band rejection characteristic becomes deteriorated.

The lattice period P of the metal pattern is determined so as to have a relation λ₀ and P<λ₀<n_{wg}P with the transmission central wavelength AO. The metal material constituting the metal pattern may be at least one selected from the group consisting of Au, Ag, Al, Cu, Pt, Pd, Ni, Co, Fe, Mn, Cr, Mo, W, V, Ta, Nb, Hf, Pb, Sb, Bi, and alloys thereof. The thickness of the metal patterns may be made from 5 nm to 500 nm. When the thickness is reduced to 5 nm or less, the surface scattering effect of the electron increases the light loss due to the metal itself, and if the thickness is too large, a resonance effect occurs in the vertical direction of the slit structure. Therefore, it has a disadvantage in that it may give an unfavorable effect to the formation of a single transmission band and it is difficult to realize a process.

If the material used for the optical waveguide layer 130 is optically transparent in the operating wavelength range and has a higher refractive index than the cladding layer, organic materials, inorganic materials, and mixtures thereof, compounds, and the like may be used without restriction. For example, the material may include oxides such as SiO₂, Al₂O₃, TiO₂, MgO, ZnO, ZrO₂, In₂O₃, SnO₂, CdO, Ga₂O₃, Y₂O₃, WO₃, V₂O₃, BaTiO₃ and PbTiO₃, nitrides such as Si₃N₄ and Al₃N₄, phosphides such as InP and GaP, sulfides such as ZnS and As₂S₃, fluorides such as MgF₂, CaF₂, NaF, BaF₂, PbF₂, LiF, and LaF, carbide such as SiC, selenides such as ZnSe, inorganic materials composed of a semiconductor such as Si and Ge and a mixture or compound thereof, and organic materials such as polycarbonate, polymethyl methacrylate (PMMA), polydimethylsiloxane (PDMS), cyclic polyolefin, styrene polymer or Teflon, and a mixtures or compound thereof.

Like the optical waveguide layer 130, if the cladding layer 110 is optically transparent in the operating wavelength band and has a refractive index lower than that of the optical waveguide layer 130, organic materials, inorganic materials, and mixtures thereof may be used without restriction. The out-of-band rejection characteristic may be expected to be improved by configuring the material of the cladding layer 110 to allow the refractive index difference with respect to the optical waveguide layer 130 to be greatly increased.

As described above, under the conditions that the optical waveguide layer 130 is formed on the plurality of metal patterns 120 and the incident light is incident on the optical waveguide layer, the present inventors find that it is possible to form a resonant transmission band by coupling with a waveguide mode.

In such a way, according to the configuration in which the optical waveguide layer 130 is formed on the plurality of metal patterns 120, it is advantageous to reduce the spacing in the integration process with the optical detector, and it is possible to eliminate the damage of the optical waveguide material and structure which may occur in the etching process for manufacturing the metal lattice. Furthermore, the function as a protective layer of the metal lattice may be added. In addition, since the thickness of the optical waveguide layer 130 may be monitored in real time in the process of forming the optical waveguide layer 130, there is an advantage in the thickness optimization process.

Referring to FIG. 2, it is shown as an example that the plurality of metal patterns 120 are patterned into a two-dimensional slit mesh shape. In the example of FIG. 2, although it is shown that straight slits are provided between a plurality of metal patterns, the slits are not always straight lines. That is, all shapes of the slit that are curved, the combination of the straight line and the curved line, are refracted at different angles are possible.

On the other hand, it is confirmed that it is possible to have particularly excellent characteristics when the width ratio of the slit shape with respect to the period of the metal patterns is limited to 1/3 or less. The excellent characteristics mean that the transmission band may be formed with a very small half-width, and the out-of-band rejection characteristic is improved. Since the metal patterns are patterned in a rectangular shape, the slits are formed in a mesh shape.

This will be described in more detail. When defining the period as P1, P1 is equal to the sum of the width D1 of the metal patterns and the width S1 of the slit. At this time, the ratio of the width S1 of the slit to the period P1 of the metal patterns may be 1/30 to 1/3. When the width of the slit is relatively small, the half-width of the transmission band is reduced and the out-of-band rejection effect is improved. However, the transmission peak is reduced in size. On the contrary, when the width of the slit is relatively wide, the size of the transmission band is increased and the out-of-band rejection effect is reduced.

FIG. 3 is a view showing examples of planar structures of metal patterns. Referring to FIG. 3, both a one-dimensional linear lattice structure and a two-dimensional lattice structure are applicable. In the case of the one-dimensional linear lattice structure, since the resonance transmission mode occurs only when the polarization direction of the incident light is perpendicular to the slit extending in parallel, it is necessary to provide a separate linear polarizer. The 2D lattice structure may be a square lattice or hexagonal lattice structure, and a metal nanostructure pattern may have various shapes such as square and polygonal structures.

On the other hand, it is possible to manufacture an optical device as the optical detector 200 corresponds to the optical filter 100 of the present invention. The optical filter 100 may be integrated directly with the optical detector 200 or may be separately manufactured in a module form and attached to each other. In the case where the optical filter 100 is separately manufactured, the optical filter 100 may be fabricated on a separate substrate and attached to a module having an optical detector.

A separate passivation layer 210 may be formed between the optical detector 200 and the optical filter 100. This case may be more effective compared with a case where the optical filter 100 is directly integrated with the optical detector 200.

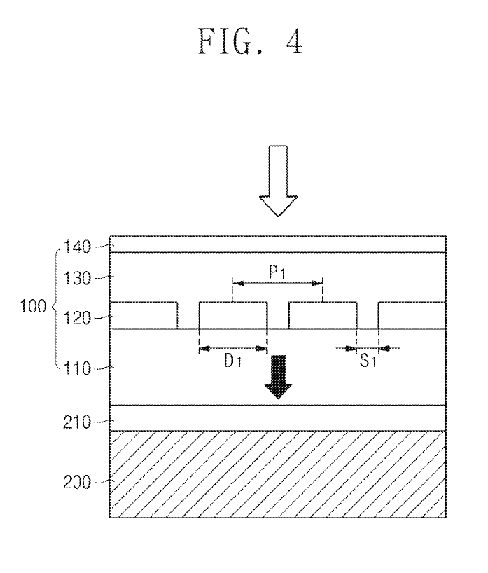

FIG. 4 is a view showing a cross section of an optical filter according to another embodiment of the present invention. For convenience of explanation, when a difference from the optical filter of FIG. 1 is described mainly, in FIG. 4, another low reflection coating layer 140 and/or a protective layer (not shown) are further formed on the optical waveguide layer 130. The low reflection coating layer 310 may be formed by coating a thin film layer having a refractive index satisfying a graded index condition between the optical waveguide layer 130 and a neighboring medium, or a nano-cone structure of a moth eye shape.

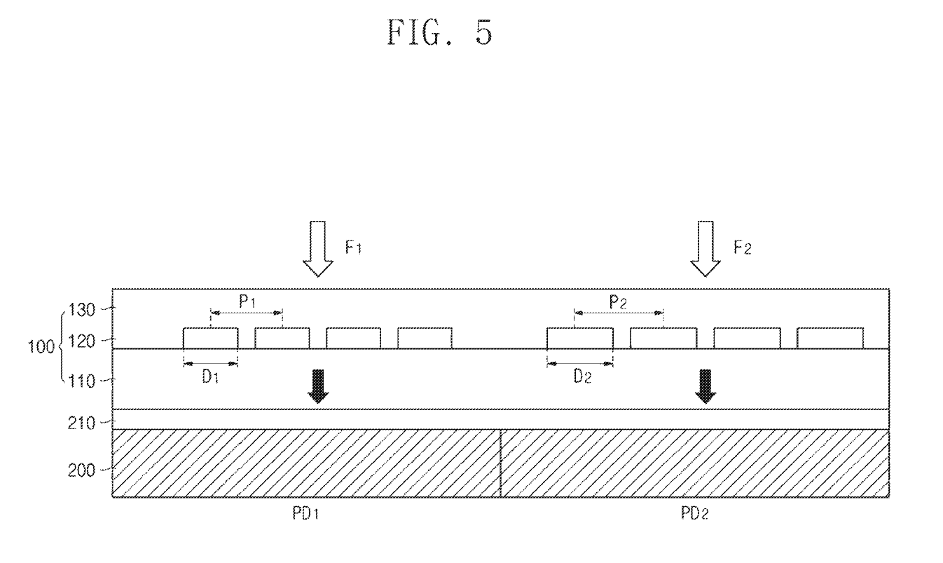

FIG. 5 is a view showing a cross section of an optical filter according to another embodiment of the present invention. Referring to FIG. 5, a plurality of metal patterns has at least two regions having different periods, and each region filters different wavelengths.

The optical filter 100 according to the present invention embodiment is composed of a plurality of filter regions F1 and F2. On the other hand, a spectrometer configured with the optical filter is composed of a plurality of filter regions F1 and F2 and corresponding light detection regions PD1 and PD2. The filter regions F1 and F2 are configured to filter light of different wavelengths and correspond to the light detection regions PD1 and PD2, respectively.

On the other hand, each of the filter regions F1 and F2 may be realized in such a manner that the duty cycle or charge rate of the metal patterns is the same or only the slit width, which is the gap between the metal patterns, is kept constant. However, the period of the F1 filter region and the period of the F2 filter region are changed.

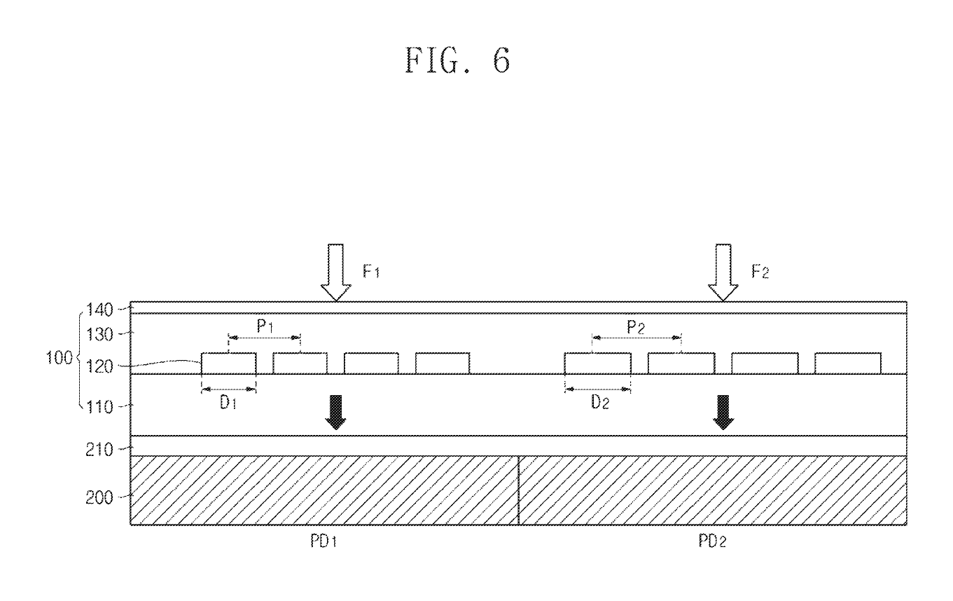

FIG. 6 is a view showing a cross section of an optical filter according to another embodiment of the present invention. For convenience of explanation, when a difference from the optical filter of FIG. 5 is described mainly, in FIG. 4, another low reflection coating layer 140 and/or a protective layer (not shown) are further formed on the optical waveguide layer 130.

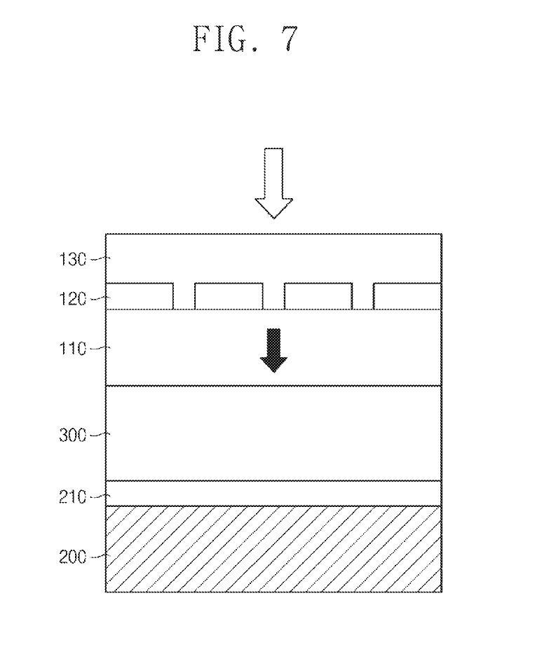

FIG. 7 is a view showing a cross section of an optical filter according to another embodiment of the present invention. For convenience of explanation, differences from the optical filter of FIG. 1 will be mainly described. Referring to FIG. 7, a substrate 300 is added. This structure is applied when the refractive index of the substrate 300 is higher than that of the optical waveguide layer. That is, when a substrate having a refractive index higher than that of the optical waveguide layer is used, a cladding layer 110 having a low refractive index is inserted between the substrate and the metal patterns.

The coupling layer 210 is disposed between the substrate 300 and the optical detector 200 and may use oil or the like for matching air or a refractive index.

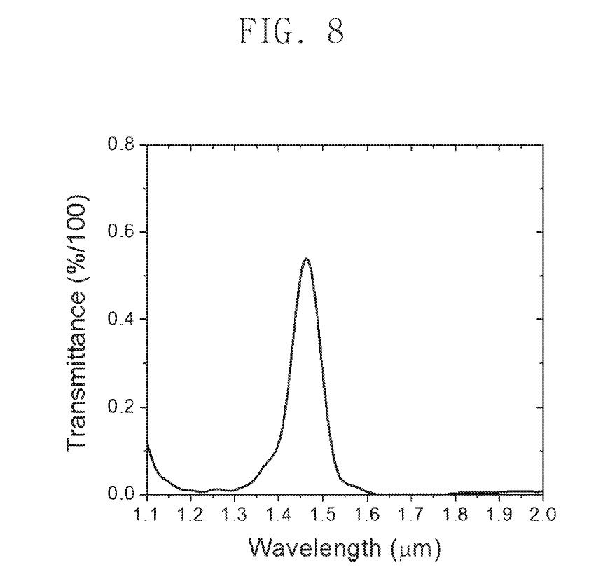

FIG. 8 shows an example of performing a finite difference time domain method (FDTD) on the structure of FIG. 7. A transmission spectrum is shown assuming that an optical waveguide having a thickness of 350 nm is formed on an Au square disc having a square lattice structure with a period of 800 nm and the incident light travels to the substrate through the optical waveguide layer. The thickness of the Au square disk was 50 nm, and the width was 700 nm. It is assumed that the refractive index of the optical waveguide layer is 2.1 and that a cladding layer having a refractive index of 1.35 and a thickness of 500 nm is formed on the Si substrate. It may be seen that a resonant mode transmission band having a relatively high transmittance at a wavelength of about 1.46 μm and a narrow half-width is formed. In addition, it may be confirmed that excellent out-of-band rejection characteristics are obtained at a wavelength of 1.1 μm or more.

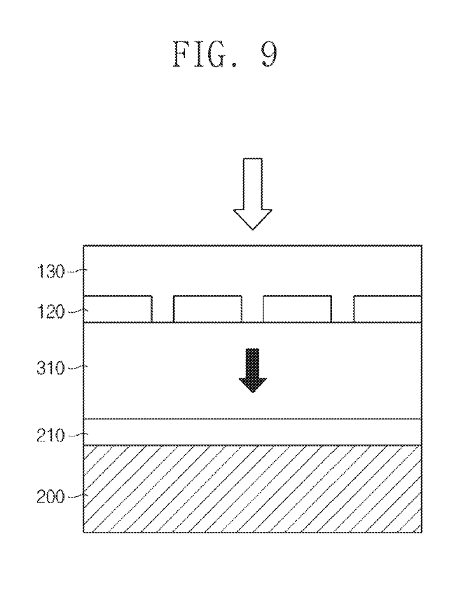

FIG. 9 is a view showing a cross section of an optical filter according to another embodiment of the present invention. Compared with FIG. 7, the structure uses a substrate 310 having a refractive index lower than that of the optical waveguide layer. In this case, since a low refractive index substrate 310 functions as a cladding layer 110, a separate cladding layer 110 is not required. As the low refractive index substrate 310, a silica, quartz, or glass substrate may be used.

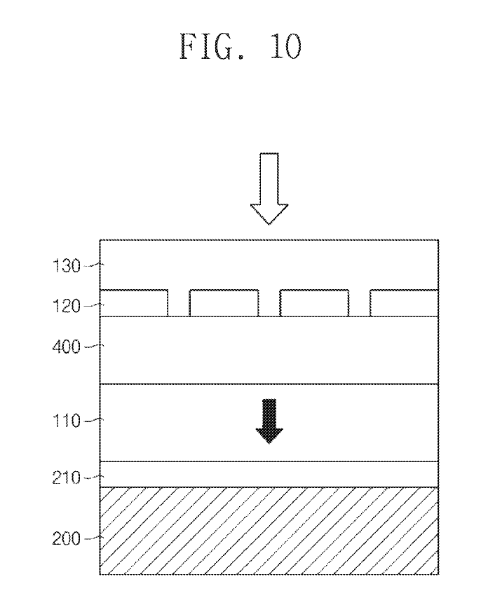

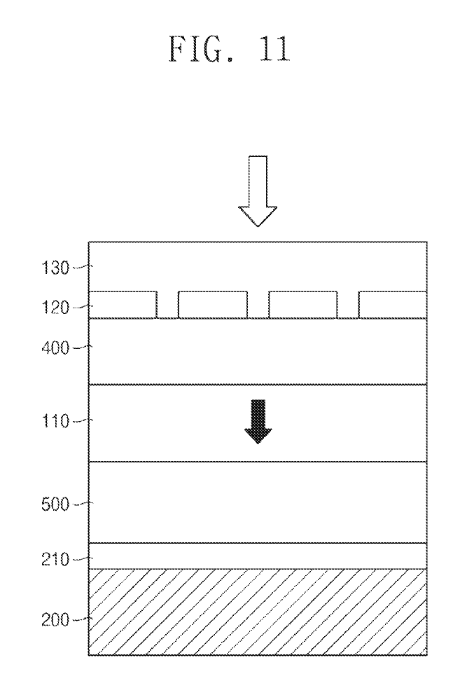

FIG. 10 is a view showing a cross section of an optical filter according to another embodiment of the present invention. For convenience of explanation, differences from the optical filter of FIG. 1 will be mainly described.

In relation to the optical filter of FIG. 10, by adding the optical waveguide layer 130 formed on the metal patterns 120, a separate optical waveguide layer 400 is added between the metal patterns 120 and the cladding layer 110. According to this structure, due to the coupling between the waveguide mode of the upper light lattice waveguide structure and the waveguide mode of the lower light lattice waveguide structure, the transmission efficiency of the resonance transmission mode may be increased, and additional spectral refinement effects such as out-of-band rejection may be expected.

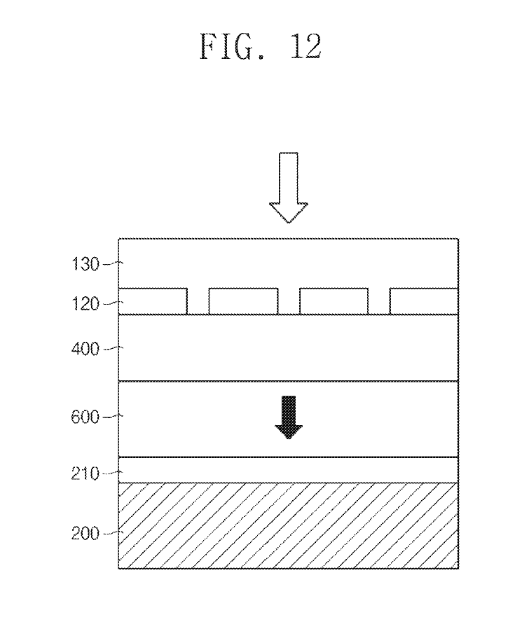

FIG. 11 is a view showing a cross section of an optical filter according to another embodiment of the present invention. Duplicate description will be omitted for convenience of explanation. The optical filter of FIG. 11 has a structure in which a separate optical waveguide layer 400 is added to the optical filter structures of FIGS. 7 and 8. That is, a separate optical waveguide layer 400 is added between the metal patterns 120 and the cladding layer 110. When the refractive index of the substrate 500 is larger than that of the optical waveguide layer, that is, when a substrate having a relatively high refractive index such as SiGe, Si, or Ge is used, the structure is suitable.

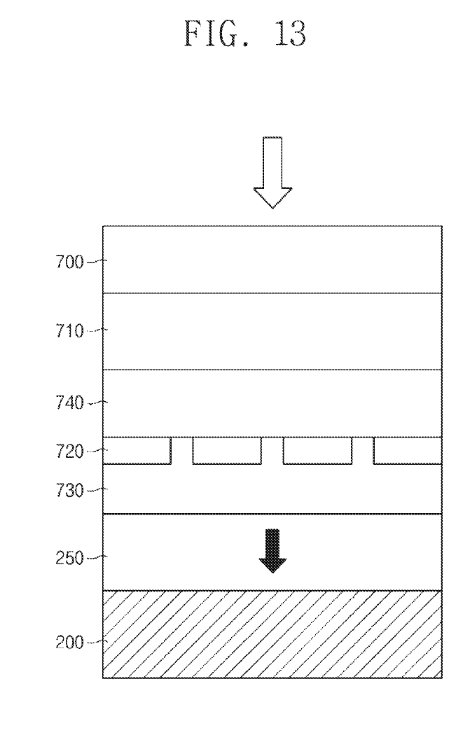

FIG. 12 is a view showing a cross section of an optical filter according to another embodiment of the present invention. Duplicate description will be omitted for convenience of explanation. The optical filter of FIG. 12 has a structure in which a separate optical waveguide layer 400 is added to the optical filter structure of FIG. 9. That is, a separate optical waveguide layer 400 is added between the metal patterns 120 and the substrate 600. In this case, since a low refractive index substrate 310 functions as a cladding layer 110, a separate cladding layer 110 is not required. In this case, the substrate 600 may be a low refractive index substrate such as silica, quartz, and glass substrates.

FIG. 13 is a view showing a cross section of an optical filter according to another embodiment of the present invention. The optical filter structure of FIG. 13 is different from the structure of the optical filters of FIGS. 1 to 12 in that light enters the substrate 700 and proceeds to the inside.

That is, the optical filter of FIG. 13 includes a substrate 700, a cladding layer 710 formed on the substrate, and an optical waveguide layer 740 on the cladding layer 710, and includes a plurality of metal patterns periodically patterned on the optical waveguide layer 740. In addition, an additional optical waveguide layer 730 is further provided on the plurality of metal patterns 720. Then, these entire structures are arranged so as to correspond to the optical detector 200 with the coupling layer 250 therebetween.

According to the method of incidence through the substrate 700, the metal lattice layer is prevented from being exposed to the outside, thereby enhancing the environmental resistance.

On the other hand, the optical waveguide layer 730 in direct contact with the plurality of metal patterns 720 may be replaced with a buffer layer (not shown) having a low refractive index. The difference between the optical waveguide layer and the buffer layer is that that the optical thickness of the buffer layer represented by the product of the refractive index and the thickness is formed to be less than a certain size so that the waveguide mode is not formed.

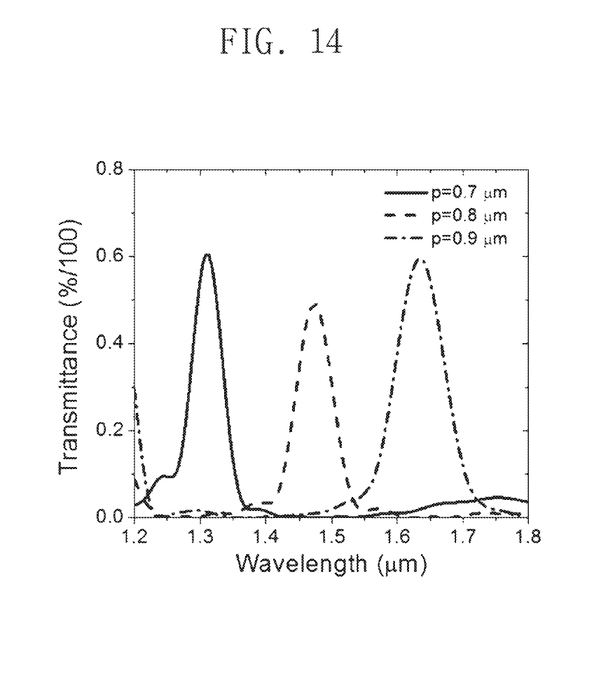

FIG. 14 shows an example of performing an FDTD computer simulation method on the structure of FIG. 13. It is assumed that a cladding layer having a refractive index of 1.45 and a thickness of 500 nm formed on a Si substrate, and an optical waveguide layer having a refractive index of 2.0 and a thickness of 350 nm are provided and a Au square disc having a thickness of 50 nm thereon forms a square lattice structure. The width of a slit is fixed at 100 nm and shows the transmission spectrum of the light incident through the substrate surface when the lattice period changes from 700 nm to 900 nm. It may be seen that the resonant mode transmission band having a narrow half-width of a relatively high transmittance was well formed, and the center wavelength was shifted to a long wavelength region at a constant interval according to the increase in the period.

On the other hand, an additional low reflective coating layer 140 and/or a protective layer (not shown) may be further formed on the substrate 700.

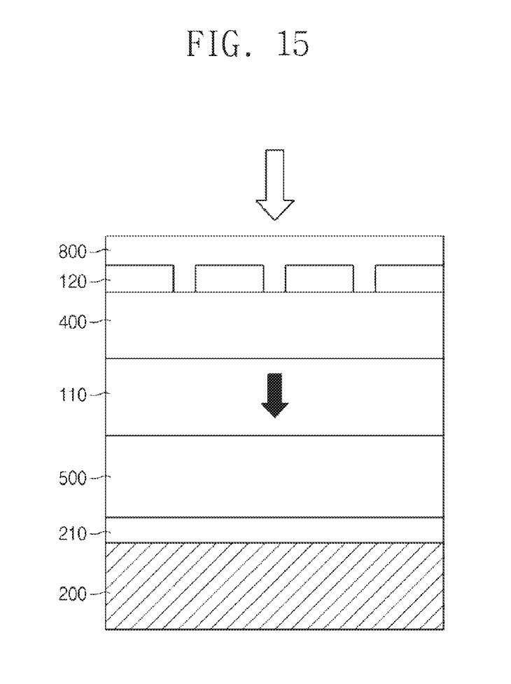

FIG. 15 is a view showing a cross section of an optical filter according to another embodiment of the present invention.

The optical filter of FIG. 15 differs from the optical filter of FIG. 11 in that a low refractive index buffer layer 800 is formed on a plurality of metal patterns 120. The buffer layer 800 is formed to have a certain optical thickness or less so as not to form a waveguide mode. The buffer layer 800 greatly may increase the intensity of the transmission band and may also function as a protective layer.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

1. An optical filter comprising:
a cladding layer;
a plurality of metal patterns configured to form a periodic lattice structure on the cladding layer; and
an optical waveguide layer on the plurality of metal patterns,
wherein light travels from the optical waveguide layer to the cladding layer.

2. The optical filter of claim 1, wherein the plurality of metal patterns is patterned to form a two-dimensional slit mesh structure.

3. The optical filter of claim 1, wherein a ratio of a slit width to a period of the plurality of metal patterns is 1/30 to 1/3.

4. The optical filter of claim 1, wherein the plurality of metal patterns has at least two regions having different periods and each region is a filter region for filtering different wavelengths.

5. The optical filter of claim 1, wherein an antireflection layer is further provided on the optical waveguide layer.

6. The optical filter of claim 1, wherein the cladding layer is a substrate.

7. The optical filter of claim 6, wherein a separate substrate is added under the cladding layer.

8. The optical filter of claim 1, wherein a separate optical waveguide layer is further provided between the cladding layer and the plurality of patterns.

9. The optical filter of claim 1, wherein a period of the plurality of metal patterns is configured to be smaller than a central wavelength to be filtered by the optical filter.

10. An optical device comprising:
the flat plate optical filter of claim 1; and
an optical detector corresponding to the optical filter.

11. The optical device of claim 10, wherein a plurality of metal patterns has at least two regions having different periods and each region is a filter region for filtering different wavelengths.

12. The optical device of claim 10, wherein a passivation layer is further added between the optical filter and the optical detector.

13. The optical device of claim 10, wherein the optical device is one of a non-dispersion infrared sensor, a spectrometer, a CMOS image sensor, or a hyper-spectral image sensor.

14. An optical filter comprising:
a substrate;
a cladding layer on the substrate;
a plurality of metal patterns periodically patterned on the cladding layer; and
a first optical waveguide layer on the plurality of metal patterns,
wherein light travels from the substrate to the first optical waveguide layer.

15. The optical filter of claim 14, wherein a second optical waveguide layer is further added between the cladding layer and the plurality of metal patterns.

16. An optical device comprising:
the flat plate optical filter of claim 14; and
an optical detector corresponding to the optical filter.
